(19) United States
(12) Patent Application Publication
(10) Pub. No.: US 2003/0028272 A1
(43) Pub. Date: Feb. 6, 2003

(54) Audio data delivery apparatus for permitting a terminal to record and reproduce audio data on a plurality of recording media without providing a recording device having a large capacity

(75) Inventor: Atsuko Sugiura, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/211,678

(22) Filed: Aug. 2, 2002

(30) Foreign Application Priority Data
Aug. 3, 2001 (JP) 2001-236725

(51) Int. Cl. H04L 9/00; H04K 1/00; G06F 17/00; G06F 17/60

(52) U.S. Cl. 700/94; 705/51

(57) ABSTRACT

An audio data delivery apparatus is disclosed including a data server and a license server. The data server stores audio data on a plurality of recording media. When audio data on a recording medium is recorded in a terminal, the terminal transmits a reproduction key issuance request to the license server for reproducing the audio data. In response to the issuance request from the terminal, the license server issues a reproduction key to the terminal for reproducing the audio data on the recording medium indicated by the terminal. The terminal stores the reproduction key issued by the license server in a memory as the audio data on the recording medium. When audio data on a recording medium is reproduced in the terminal, the terminal reads a reproduction key from the memory, and transmits a reproduction request including this reproduction key to the license server. The license server instructs the data server to deliver the audio data on the recording medium corresponding to the reproduction key included in the reproduction request transmitted from the terminal from the data server to the terminal. The delivered audio data is reproduced in the terminal.

### BACKGROUND OF THE INVENTION

1. Field of the Invention

The present invention relates to an audio data delivery apparatus for permitting a terminal to record and reproduce audio data on a plurality of recording media such as CD.

2. Description of the Related Art

Conventionally, some terminals such as personal computers may compress audio data on a recording medium such as CD to record the compressed audio data in a recording device such as a hard disk drive, and reproduce the audio data recorded in the recording device. Also, with the recent progress of network technologies, compressed audio data on a recording medium may be downloaded through a network for recording in a recording device, so that the compressed audio data recorded in the recording device is decompressed for reproduction.

As an exemplary application of the foregoing technique, when audio data on a plurality of music CDs can be recorded and reproduced, for example, in a terminal, the terminal can be used as a jukebox.

However, in the aforementioned prior art, since audio data is recorded in the terminal, the terminal must be provided with a recording device having a large capacity for recording and reproducing audio data on a plurality of recording media.

### SUMMARY OF THE INVENTION

It is an object of the present invention to provide an audio data delivery apparatus which permits a terminal to record and reproduce audio data on a plurality of recording media without providing a recording device having a large capacity in the terminal.

An audio data delivery apparatus according to the present invention includes a data server and a license server.

The data server stores audio data on a plurality of recording media. The license server issues a reproduction key to a terminal for reproducing audio data on a recording medium indicated by the terminal from among the audio data on the recording media stored in the data server when the audio data on the recording medium is recorded in the terminal, and instructs the data server to deliver the audio data on the recording medium corresponding to a reproduction key indicated by the terminal from the data server to the terminal when the audio data on the recording medium is reproduced in the terminal.

The terminal, in turn, stores the reproduction key issued by the license server as audio data on a recording medium, when it records the audio data on the recording medium, and transmits the reproduction key to the license server to receive the audio data on the recording medium corresponding to the reproduction key when it reproduces the audio data on the recording medium. In this way, the terminal can record and reproduce audio data on a plurality of recording media without increasing the capacity of a recording device such as a memory.

According to a first embodiment of the present invention, the terminal comprises reproduction key requesting means, a memory, data delivery requesting means, and data reproducing means; the data server comprises data recording means, a table, and data delivery control means; and the license server comprises reproduction key issuing means, recording means, and reproduction processing means.

When audio data on a recording medium is recorded in the terminal, the reproduction key requesting means transmits to the license server a reproduction key issuance request for a reproduction key for reproducing the audio data on the recording medium. The reproduction key issuance request includes ID information added to the recording medium. The memory stores the reproduction key issued by the license server. When audio data on a recording medium is reproduced corresponding to a reproduction key stored in the memory, the data delivery requesting means transmits to the license server a reproduction request for the audio data on the recording medium corresponding to the reproduction key. The reproduction request includes the reproduction key. The data reproducing means reproduces audio data on a recording medium delivered from the data server.

The data recording means records therein audio data on a plurality of recording media. The table records therein audio data on a recording medium recorded in the data recording means and ID information added to the recording medium in relation to each other. When a data delivery request is transmitted from the license server, the data delivery control means recognizes audio data on a recording medium accompanied with ID information included in the data delivery request by referencing the table, and controls a delivery of the audio data on the recording medium from the data recording means to the terminal.

When a reproduction key issuance request is transmitted from the terminal, the reproduction key issuing means issues a reproduction key corresponding to ID information included in the reproduction key issuance request to the terminal. The recording means records therein the reproduction key issued by the reproduction key issuance processing means and ID information of a recording medium corresponding to the reproduction key in relation to each other. When a reproduction request is transmitted from the terminal, the reproduction processing means recognizes ID information of a recording medium corresponding to a reproduction key included in the reproduction request by referencing the recording means, and transmits to the data server a data delivery request for audio data on a recording medium accompanied with the ID information. The data delivery request includes the ID information.

In a second embodiment of the present invention, the terminal is identical in configuration to the terminal of the first embodiment. The data server further comprises data existence determining means, and correspondingly, reproduction key issuing means in a license server partially differs in the processing from the reproduction key issuing means in the license server of the first embodiment.

The data existence determining means determines whether or not audio data on a recording medium queried from the license server is recorded in the data recording means by referencing the table. The reproduction key issuing means in the license server issues a reproduction key to a terminal when the data existence determining means determines that the data server stores the audio data queried by the reproduction key issuing means.

In a third embodiment of the present invention, the terminal further comprises terminal ID storing means for storing a terminal ID of the terminal, and correspondingly, the reproduction key requesting means partially differs in the processing from the reproduction key requesting means in the first and second embodiments. The data server is identical in configuration to the data server of the second embodiment, while the recording means and reproduction key issuance processing means in the license server partially differ in the processing from the recording means and reproduction key issuing means in the second embodiment.

When audio data on a recording medium is recorded in the terminal, the reproduction key requesting means in the terminal transmits to the license server a reproduction key issuance request for a reproduction key for reproducing the audio data on the recording medium. The reproduction key issuance request includes ID information added to the recording medium, and a terminal ID stored in the terminal ID storing means. The recording means in the license server records therein for each terminal a reproduction key issued to the terminal, ID information of a recording medium corresponding to the reproduction key, and the number of times the reproduction key has been issued in relation to one another. When a reproduction key issuance request is transmitted from the terminal, the reproduction key issuing means in the license server recognizes the terminal based on a terminal ID included in the reproduction key issuance request, recognizes the number of times a reproduction key corresponding to ID information included in the reproduction key issuance request has been issued to the terminal by referencing the recording means, and issues the reproduction key to the terminal when the number of times of issuances is less than a predetermined allowable number of times.

The reproduction key issuing means in the license server records for each terminal the number of times a reproduction key has been issued to the terminal, and when a reproduction key issuance request is transmitted from a terminal, recognizes the number of times the reproduction key has been issued to the terminal by referencing the recording means. Then, the reproduction key is issued to the terminal when reproduction key issuing means determines that the number of times of issuance is less than the predetermined allowable number of times. Since the number of times a reproduction key is issued to a terminal is limited in this manner, it is possible to reduce the possibility that the reproduction key is fraudulently copied.

In a fourth embodiment of the present invention, the terminal is identical in configuration to the terminals of the first and second embodiments; the data server is identical in configuration to the data servers of the second and third embodiments; and the license server partially differs in the processing of reproduction processing means and recording means from the license server of the second embodiment.

Specifically, the recording means in the license server records a reproduction key, ID information of a recording medium corresponding to the reproduction key, and validity of the reproduction key in relation to one another. When a reproduction request is transmitted from a terminal, the reproduction processing means in the license server determines whether or not the reproduction key included in the reproduction request is valid by referencing the recording means, and transmits to the data server a data delivery request including ID information corresponding to the reproduction key included in the reproduction request when it determines that the reproduction key is valid.

The recording means in the license server records therein the validity of a reproduction key, and the reproduction processing means determines the validity of a reproduction key included in a reproduction request, when it is transmitted from a terminal, by referencing the recording means. Then, audio data is delivered from the data server to the terminal when it is determined that the reproduction key is valid. Thus, the reproduction key can be prevented from fraudulent uses by recording fraudulently used reproduction keys as invalid in the recording means.

In a fifth embodiment of the present invention, the terminal further comprises digital recording processing means and recording control means in addition to the components of the terminal of the second embodiment. The data server and license server are identical in configuration to those of the second embodiment.

The digital recording processing means digitally records audio data on a recording medium for storage in a memory. When audio data on a recording medium is recorded in the terminal, the recording control means determines whether or not ID information is added to the recording medium. The recording control means controls reproduction key requesting means to transmit a reproduction key issuance request when it determines that the ID information is added to the recording medium, whereas the recording control means controls the digital recording processing means to digitally record the audio data on the recording medium when it determines that the ID information is not added to the recording medium.

In addition, the terminal may further comprise reproduction control means operative when the terminal reproduces audio data on a recording medium stored in the memory for determining whether or not the audio data on the recording medium is stored as a reproduction key, controlling the data delivery requesting means to transmit a reproduction request when determining that the audio data on the recording medium is stored as the reproduction key, and controlling the data reproducing means to reproduce the audio data on the recording medium stored in the memory when determining that the audio data on the recording medium is not stored as the reproduction key.

When audio data on a recording medium is recorded in the terminal, it is determined whether or not ID information is added to the recording medium, and a reproduction key issuance request is transmitted to the license server when the ID information is added to the recording medium, whereas the audio data on the recording medium is digitally recorded when the ID information is not added. Also, when audio data on a recording medium is reproduced in the terminal, it is determined whether or not the audio data is stored as a reproduction key in the memory, and a reproduction request is transmitted to the license server when the audio data is stored as a reproduction key, whereas the audio data recorded in the memory is reproduced as it is when it is not stored as a reproduction key. It is therefore possible to record and reproduce audio data on a recording medium irrespective of whether or not ID information is added to the recording medium.

If the memory in the terminal is portable, audio data on a recording medium stored as a reproduction key in the terminal can be reproduced in another terminal.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram illustrating the configuration of an audio data recording/reproducing system according to a first embodiment of the present invention;

FIG. 2 is a table showing exemplary contents recorded in a recording unit within a license server illustrated in FIG. 1;

FIG. 3 is a flow chart for explaining the operation of the audio data recording/reproducing system illustrated in FIG. 1 when audio data is recorded;

FIG. 4 is a flow chart for explaining the operation of the audio data recording/reproducing system illustrated in FIG. 1, when audio data is reproduced;

FIG. 5 is a block diagram illustrating the configuration of an audio data recording/reproducing system according to a second embodiment of the present invention;

FIG. 6 is a flow chart for explaining the operation of the audio data recording/reproducing system illustrated in FIG. 5 when audio data is recorded;

FIG. 7 is a block diagram illustrating the configuration of an audio data recording/reproducing system according to a third embodiment of the present invention;

FIG. 8 is a table showing exemplary contents recorded in a recording unit within a license server illustrated in FIG. 7;

FIG. 9 is a flow chart for explaining the operation of the audio data recording/reproducing system illustrated in FIG. 7 when audio data is recorded;

FIG. 10 is a block diagram illustrating the configuration of an audio data recording/reproducing system according to a fourth embodiment of the present invention;

FIG. 11 is a table showing exemplary contents recorded in a recording unit within a license server illustrated in FIG. 10;

FIG. 12 is a flow chart for explaining the operation of the audio data recording/reproducing system illustrated in FIG. 10 when audio data is reproduced;

FIG. 13 is a block diagram illustrating the configuration of an audio data recording/reproducing system according to a fifth embodiment of the present invention;

FIG. 14 is a flow chart for explaining the operation of the audio data recording/reproducing system illustrated in FIG. 13 when audio data is recorded; and

FIG. 15 is a flow chart for explaining the operation of the audio data recording/reproducing system illustrated in FIG. 13 when audio data is reproduced.

### DESCRIPTION OF THE PREFERRED EMBODIMENTS

First Embodiment

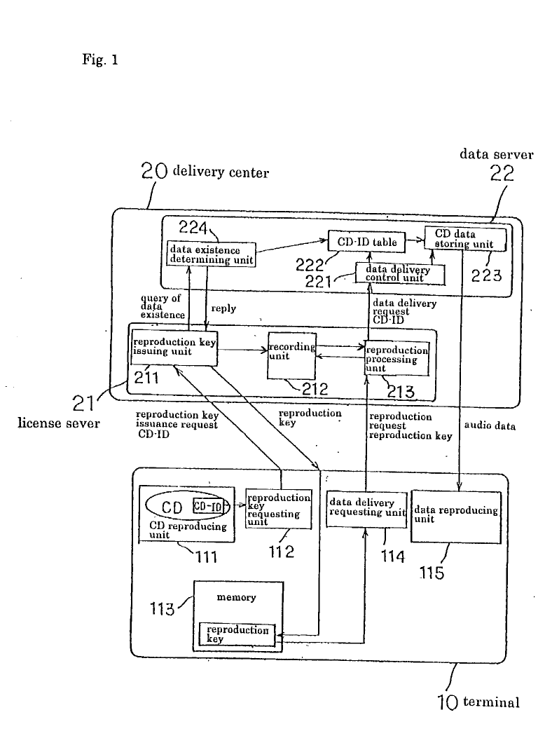

Referring now to FIG. 1, an audio data recording/reproducing system according to a first embodiment of the present invention comprises terminal 10, and delivery center 20 which functions as an audio data delivery apparatus that comprises license server 21 and data server 22. While FIG. 1 shows only one terminal 10, a plurality of terminals 10 may exist in the system.

Terminal 10 comprises CD reproducing unit 111, reproduction key requesting unit 112, memory 113, data delivery requesting unit 114, and data reproducing unit 115.

In terminal 10, only CD reproducing unit 111, reproduction key requesting unit 112 and memory 113 operate when audio data on a CD is recorded, while only data delivery requesting unit 114, data reproducing unit 115 and memory 113 operate when audio data on a CD is reproduced.

CD reproducing unit 111 is loaded with a CD which is thereby reproduced.

Reproduction key requesting unit 112 extracts a CD-ID added to a CD and transmits a reproduction key issuance request including the CD-ID to delivery center 20 when terminal 10 is to record audio data on the CD loaded in CD reproducing unit 111. The CD-ID identifies the CD (for a music CD, the artists' name or music title, or information which can identify the title of album, artists' name or music title, and the like) to which the CD-ID is added.

Memory 113 stores as audio data a reproduction key issued by delivery center 20 in response to the reproduction key issuance request transmitted by reproduction key requesting unit 112.

Data delivery requesting unit 114 reads a reproduction key stored in memory 113 and transmits a reproduction request including the reproduction key to delivery center 20 when terminal 10 is to reproduce audio data on a CD which has been recorded in memory 113 as the reproduction key.

Data reproducing unit 115 decompresses and reproduces a compressed version of audio data delivered from delivery center 20 in response to a reproduction request transmitted from data delivery requesting unit 114.

License server 21 comprises reproduction key issuing unit 211, recording unit 212, and reproduction processing unit 213.

Upon receipt of a reproduction key issuance request from terminal 10, reproduction key issuing unit 211 queries data server 22 whether or not data server 22 stores audio data on a CD accompanied, with the CD-ID included in the issuance request. Then, reproduction key issuing unit 211 issues a reproduction key to terminal 10 when it confirms that the audio data is stored in data server 22.

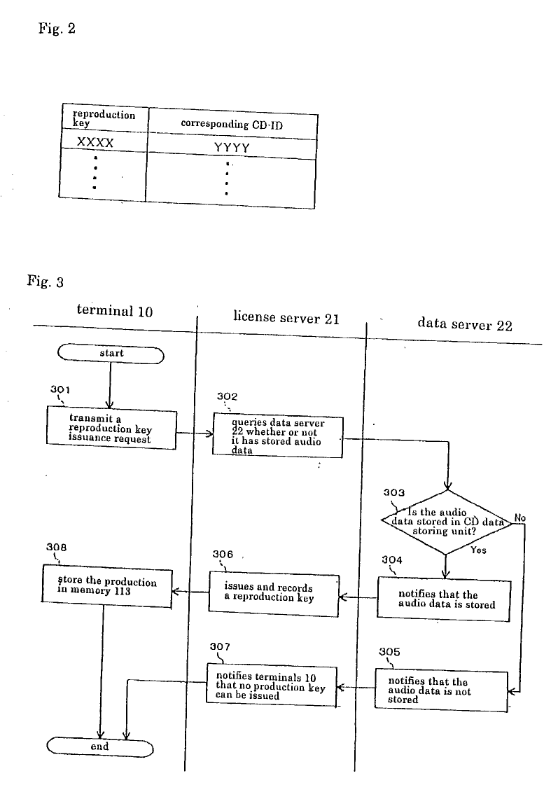

Recording unit 212 records therein the reproduction key issued by reproduction key issuing unit 211 to terminal 10 and the CD-ID corresponding to the reproduction key in relation to each other, for example, as shown in FIG. 2.

Upon receipt of a reproduction request from terminal 10, reproduction processing unit 213 acquires the CD-ID corresponding to a reproduction key included in the reproduction request by referencing recording unit 212, and transmits a data delivery request for audio data including the CD-ID to data server 22.

Data server 22 comprises data delivery control unit 221, CD-ID table 222, CD data storing unit 223, and data existence determining unit 224.

CD data storing unit 223 stores audio data on a plurality of CDs in a compressed format.

CD-ID table 222 records therein audio data on CDs stored in CD data storing unit 223, and a CD-ID corresponding to the audio data in relation to each other.

Upon receipt of a data delivery request from license server 21,, data delivery control unit 221 recognizes audio data on a CD, accompanied with the CD-ID included in the data delivery request, by referencing table 222 to control CD data storing unit 223 to deliver a compressed version of the audio data to terminal 10.

Upon receipt of a query as to the presence or absence of audio data from license server 21, data existence determining unit 224 determines whether or not the audio data is stored in CD data storing unit 223 by referencing table 222, and makes a reply to license server 21.

In the following, the operation of the foregoing audio data recording/reproducing system will be explained with reference to flow charts.

First, the operation of the system for recording audio data will be explained with reference to a flow chart of FIG. 3.

First, at step 301, reproduction key requesting unit 112 in terminal 10 extracts a CD-ID from a CD loaded in CD reproducing unit 111, and transmits a reproduction key issuance request including the CD-ID to license server 21.

Upon receipt of the reproduction key issuance request from terminal 10, reproduction key issuing unit 211 in license server 21 queries data server 22 at step 302 whether or not data server 22 has stored audio data on the CD accompanied with the CD-ID included in the issuance request.

At step 303, data existence determining unit 224 in data server 22 references CD-ID table 222 to determine whether or not the audio data is stored in CD data storing unit 223. At steps 304, 305, data server 22 notifies license server 21 of the result.

In license server, 21, when it is notified from data server 22 that the audio data is stored therein, reproduction key issuing unit 211 issues a reproduction key to terminal 10, and recording unit 212 records therein the reproduction key issued to terminal 10 and the CD-ID from terminal 10 in relation to each other at step 306. Conversely, when license server 21 is notified from data server 22 that the audio data is not stored therein, reproduction key issuing unit 211 notifies terminal 10 at step 307 that no reproduction key can be issued thereto, followed by termination of the processing.

Subsequently, when a reproduction key is issued in license server 21, the reproduction key is stored in memory 113 in terminal 10 at step 308, followed by termination of the processing.

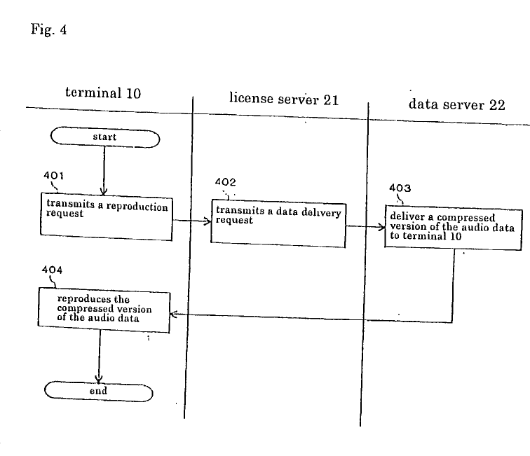

Next, the operation for reproducing audio data will be explained with reference to a flow chart of FIG. 4.

At step 401, data delivery requesting unit 114 in terminal 10 first reads a reproduction key from memory 113, and transmits a reproduction request including the reproduction key to license server 21.

Upon receipt of the reproduction request from terminal 10, reproduction processing unit 213 in license server 21 acquires a CD-ID corresponding to the reproduction key included in the reproduction request by referencing recording unit 212, and transmits a data delivery request including the CD-ID to data server 22 at step 402. In the example of FIG. 2, upon receipt of a reproduction key “XXXX” from terminal 10, reproduction processing unit 213 will transmit a CD-ID “YYYY” corresponding to the reproduction key “XXXX” to data server 22.

Upon receipt of the data delivery request from license server 21, data delivery control unit 221 in data server 22 recognizes audio data on a CD, accompanied with the CD-ID included in the data delivery request, by referencing CD-ID table 222, and instructs CD data recording unit 223 to deliver a compressed version of the audio data to terminal 10 at step 403.

Subsequently, at step 404, data reproducing unit 115 in terminal 10 reproduces the compressed version of the audio data delivered from data server 22 in real time, followed by termination of the processing.

As described above, with the first embodiment, since terminal 10 records audio data on a CD as a reproduction key, audio data on a plurality of CDs can be recorded without increasing the capacity of memory 113 in terminal 10.

Also, when memory 113 in terminal 10 is implemented by a portable recording device such as a floppy disk, a memory card and the like, audio data recorded as a reproduction key by terminal 10 can be reproduced by another terminal.

While terminal 10 comprises two sections, i.e., a recording section (section made up of CD reproducing unit 111, reproduction key requesting unit 112, and memory 113), and a reproducing section (section made up of data delivery requesting unit 114, data reproducing unit 115, and memory 113), the system of the present invention may be provided with a terminal which comprises any of these two sections.

Second Embodiment

In the first embodiment, upon receipt of a reproduction key issuance request from terminal 10, license server 21 communicates a query and a reply with data server 22 as to the presence or absence of audio data associated with the request, and issues a reproduction key to terminal 10 only when the associated audio data is stored in data server 22.

However, if data server 22 stores audio data on all CDs accompanied with CD-IDs, the communications between license server 21 and data server 22 are not needed for the query/reply as to the presence or absence of associated audio data.

Taking the foregoing in mind, in a second embodiment illustrated in FIG. 5, delivery center 20 is configured to eliminate the communications between license server 21 and data server 22 for the query/reply as to the presence or absence of associated audio data, on the assumption that data server 22 stores audio data on all CDs accompanied with CD-IDs.

The second embodiment differs from the first embodiment in that data existence determination unit 224 is removed from data server 22, and reproduction key issuing unit 211 in license server 21 performs the following processing.

Upon receipt of a reproduction key issuance request from terminal 10, reproduction key issuing unit 211 issues a reproduction key to terminal 10 without querying data server 22 as to the presence or absence of audio data on a CD accompanied with a CD-ID included in the issuance request.

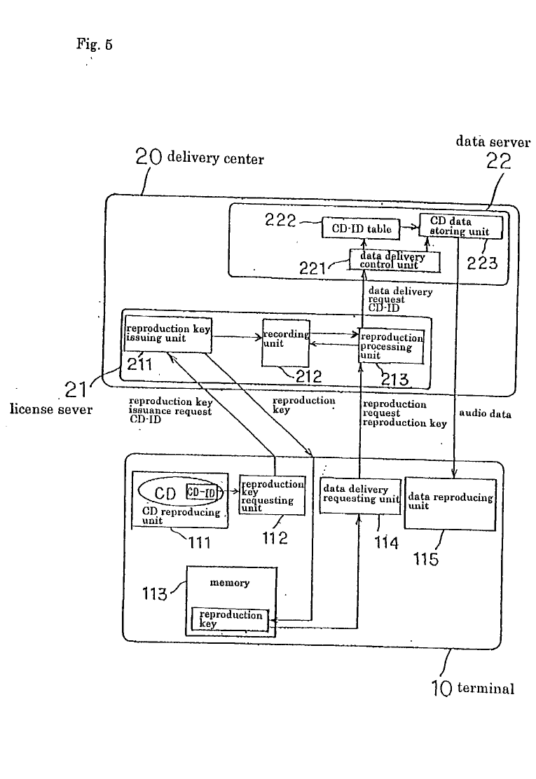

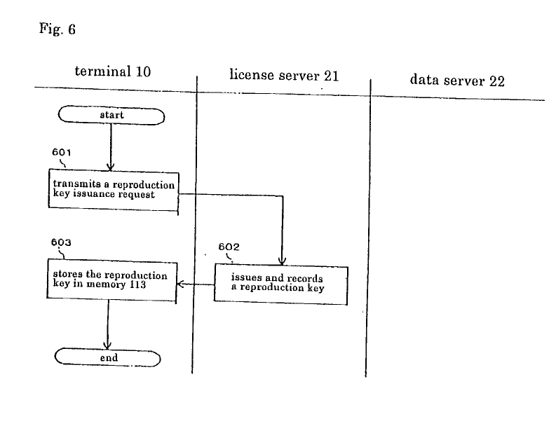

In the following, the operation of the foregoing audio data recording/reproducing system will be explained with reference to a flow chart of FIG. 6. Since the operation for reproducing audio data is similar to that of the first embodiment, the following explanation will focus only on the operation for recording audio data.

First, at step 601, reproduction key requesting unit 112 in terminal 10 extracts a CD-ID from a CD loaded in CD reproducing unit 111, and transmits a reproduction key issuance request including the CD-ID to license server 21.

Upon receipt of the reproduction key issuance request from terminal 10, reproduction key issuance processing unit 211 in license server 21 issues a reproduction key corresponding to the CD-ID included in the issuance request to terminal 10, without querying data server 22, and recording unit 212 records the reproduction key issued to terminal 10 and the CD-ID from terminal 10 in relation to each other at step 602.

Subsequently, at step 603, the reproduction key issued in license server 21 is stored in memory 113 in terminal 10, followed by termination of the processing.

As described above, with the second embodiment, since the license server 21 issues a reproduction key to terminal 10 upon receipt of a reproduction key issuance request from terminal 10, without querying data server 22 as to the presence or absence of associated audio data, it is possible to reduce time for the operation involved in issuing a reproduction key.

Third Embodiment

In the first and second embodiments, license server 21 issues a reproduction key each time it receives a reproduction key issuance request from terminal 10, so that the reproduction key is highly susceptible to fraudulent copies.

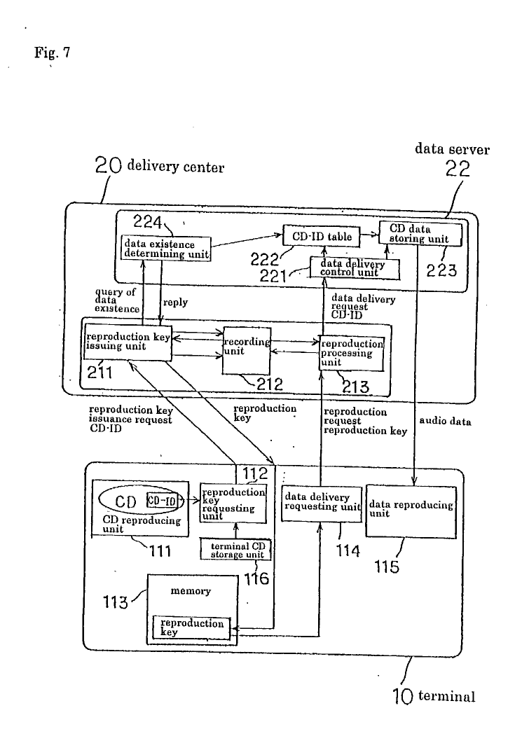

To address this problem, in a third embodiment illustrated in FIG. 7, license server 21 limits the number of times a reproduction key is issued to terminal 10 to thereby reduce the possibility that the reproduction key is fraudulently copied.

As illustrated in FIG. 7, the third embodiment differs from the first embodiment in that terminal 10 is provided with terminal ID storage unit 116, and reproduction key requesting unit 112 in terminal 10, reproduction key issuing unit 211 in license server 21, and recording unit 212 perform the following processing.

Terminal ID storage unit 116 stores a terminal ID of terminal 10. This terminal ID is unique to each terminal such as a product number, enabling any particular terminal to be identified.

When reproduction key requesting unit 112 requests license server 21 to issue a reproduction key, reproduction key requesting unit 112 extracts a CD-ID from a CD loaded in CD reproducing unit 111, and reads the terminal ID of terminal 10 from terminal ID storage unit 116, and transmits a reproduction key issuance request including the CD-ID and terminal ID to license server 21.

Upon receipt of the reproduction key issuance request from terminal 10, reproduction key issuing unit 211 confirms the number of times a reproduction key has been issued in combination of the CD-ID and terminal ID included in the issuance request by referencing recording unit 212, and determines whether or not data server 22 stores audio data on a CD accompanied with the CD-ID included in the issuance request. If it is determined that the number of times the reproduction key has been issued is less than an allowable number of times, and that the data server 22 stores the associated audio data, the reproduction key issuance processing unit 211 issues a reproduction key to terminal 10.

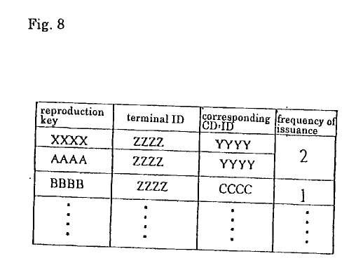

Recording unit 212 records therein a reproduction key issued by reproduction key issuing unit 211, a terminal ID of a terminal which is the destination of the reproduction key, a CD-ID corresponding to the reproduction key, and the number of times the reproduction key has been issued, in relation to one another, for example, as shown in FIG. 8.

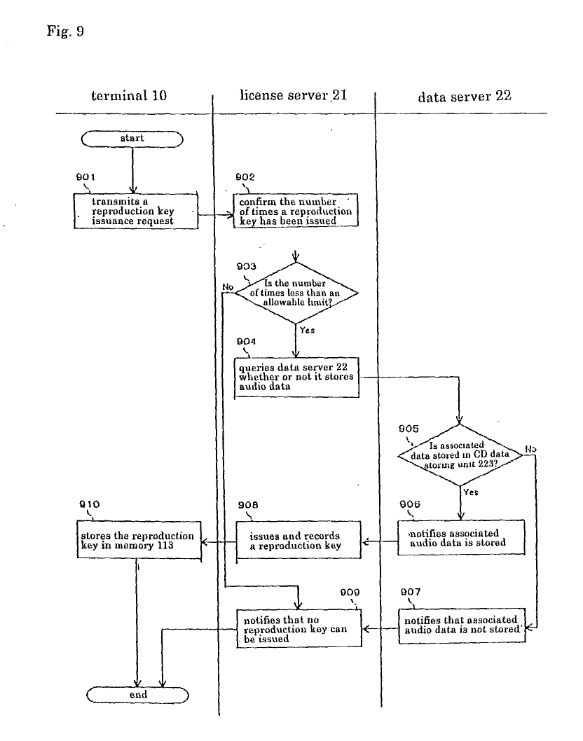

In the following, the operation of the foregoing audio data recording/reproducing system will be explained with reference to a flow chart of FIG. 9. Since the operation for reproducing audio data is similar to that of the first embodiment, the following explanation will focus only on the operation for recording audio data.

First, in terminal 10, at step 901, reproduction key requesting unit 112 first extracts a CD-ID from a CD loaded in CD reproducing unit 111, reads the terminal ID of terminal 10 from terminal ID storage unit 116, and transmits a reproduction key issuance request including the CD-ID and terminal ID to license server 21.

Upon receipt of the reproduction key issuance request from terminal 10, reproduction key issuance processing unit 211 in license server 21 recognizes terminal 10 based on the terminal ID included in the issuance request, and confirms the number of times a reproduction key has been issued to terminal 10 in combination with the CD-ID and terminal ID included in the issuance request by referencing recording unit 212 at step 902.

At step 903, reproduction key issuing unit 211 determines whether or not the number of times the reproduction key has been issued is less than an allowable number of times. Determining that the number of times the reproduction key has been issued is less than the allowable number of times, reproduction key issuing unit 211 queries data server 22 at step 904 whether or not data server 22 stores audio data on a CD accompanied with the CD-ID included in the reproduction key issuance request. For example, it is assumed that the allowable number of times for any reproduction key is uniformly set to two. When a reproduction key issuance request is made in combination with a CD-ID “CCCC” and a terminal ID “ZZZZ” in an example of FIG. 8, an associated reproduction key “BBBB” has been issued once, so that reproduction key issuing unit 211 queries data server 22 as to the presence or absence of corresponding audio data.

Data existence determining unit 224 in data server 22 determines at step 905 whether or not associated audio data is stored in CD data storing unit 223 by referencing CD-ID table 222, and notifies license server 21 of the result at steps 906, 907.

When license server 21 is notified from data server 22 that the associated audio data is stored therein, reproduction key issuing unit 211 issues a reproduction key to terminal 10 at step 908, and recording unit 212 records the reproduction key issued to terminal 10, the terminal ID of terminal 10, the CD-ID from terminal 10, and the number of times the reproduction key has been issued, in relation to one another. Conversely, when license server 21 is notified from data server 22 that associated audio data is not stored therein, reproduction key issuing unit 211 notifies terminal 10 that no reproduction key can be issued thereto at step 909, followed by termination of the processing.

Subsequently, when the reproduction key is issued in license server 21, the reproduction key is stored in memory 113 in terminal 10 at step 910, followed by termination of the processing.

If it is determined at step 903 that the number of times the reproduction key has been issued has already reached the allowable number of times, the processing proceeds to step 909, where reproduction key issuing unit 211 notifies terminal 10 that no reproduction key can be issued thereto, followed by termination of the processing.

As described above, in the third embodiment, upon receipt of a reproduction key issuance request from terminal 10, license server 21 determines whether or not the number of times a reproduction key has been issued to terminal 10 is less than the allowable number of times, and issues the reproduction key to terminal 10 when it determines so. This limits the number of times the reproduction key is issued to terminal 10, thereby making it possible to reduce the possibility that the reproduction key is fraudulently acquired and abused.

Fourth Embodiment

The third embodiment has been described in connection with the audio data recording/reproducing system which is configured to reduce the possibility that a reproduction key is fraudulently acquired and abused by limiting the number of times the reproduction key is issued to terminal 10. A fourth embodiment invalidates a reproduction key when it is found that the reproduction key has been fraudulently acquired and abused in actuality to protect the reproduction key from being fraudulently used.

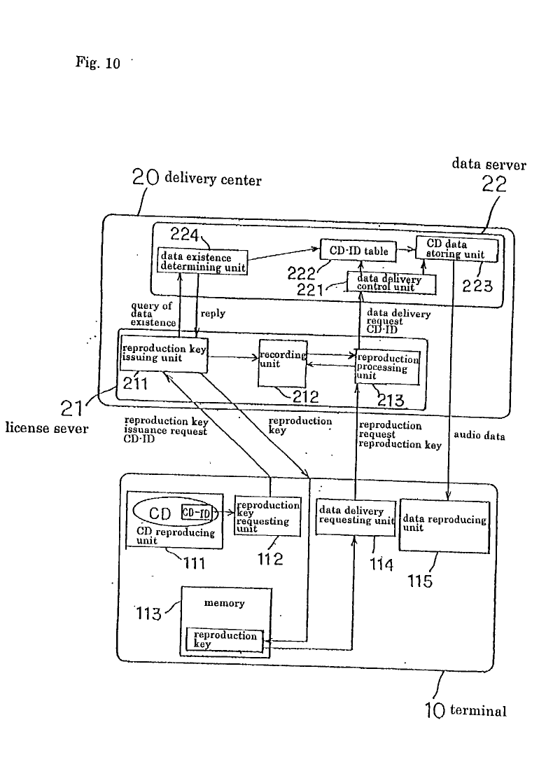

As illustrated in FIG. 10, the fourth embodiment differs from the first embodiment in that reproduction key issuing unit 211, recording unit 212 and reproduction processing unit 213 in license server 21 perform the following processing.

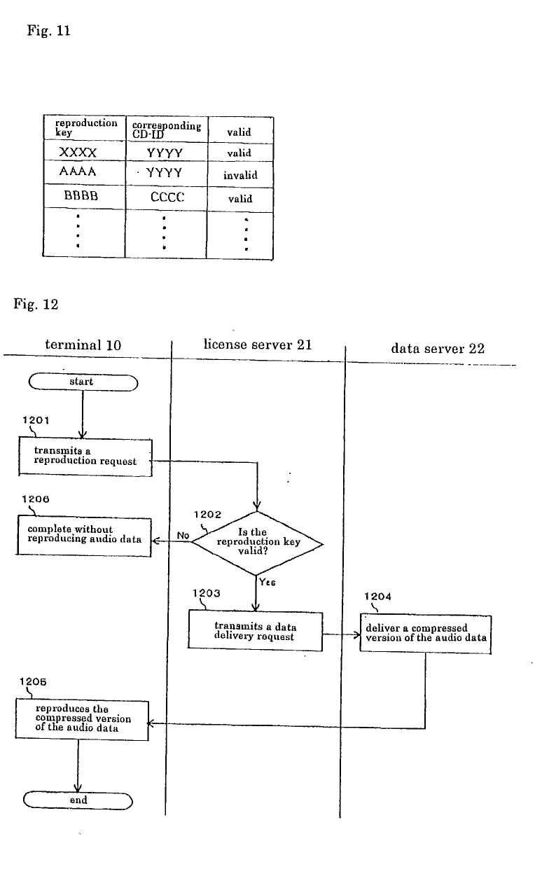

Recording unit 212 records therein a reproduction key issued by reproduction key issuance processing unit 211, a CD-ID corresponding to the reproduction key, and validity for the reproduction key in relation to one another, for example, as shown in FIG. 11.

Upon receipt of a reproduction request from terminal 10, reproduction processing unit 213 determines the validity for a reproduction key included in the reproduction request by referencing recording unit 212, acquires an associated CD-ID by referencing recording unit 212 when it determines that the reproduction key is valid, and requests data server 22 to deliver audio data.

In the following, the operation of the foregoing audio data recording/reproducing system will be explained with reference to a flow chart of FIG. 12. Since the operation for recording audio data is similar to that of the first embodiment, the following explanation will focus only on the operation for reproducing audio data.

First, at step 1201, data delivery requesting unit 114 in terminal 10 first reads a reproduction key recorded in memory 113, and transmits a reproduction request including the read reproduction key to license server 21.

Upon receipt of the reproduction request from terminal 10, reproduction processing unit 213 in license server 21 determines at step 1202 whether or not the reproduction key included in the reproduction request is valid by referencing recording unit 212.

Determining that the reproduction key is valid, reproduction processing unit 213 subsequently acquires a CD-ID corresponding to the reproduction key included in the reproduction request from terminal 10 by referencing recording unit 212, and transmits a data delivery request including the CD-ID to data server 22 at step 1203.

Upon receipt of the data delivery request from license server 21, data delivery control unit 221 in data server 22 recognizes audio data on a CD, accompanied with the CD-ID included in the data delivery request, by referencing CD-ID table 222, and instructs CD data recording unit 223 to deliver a compressed version of the audio data to terminal 10 at step 1204.

Subsequently, at step 1205, data reproducing unit 115 in terminal 10 reproduces the compressed version of the audio data sent from data server 22 in real time, followed by termination of the processing.

On the other hand, when reproduction processing unit 213 determines at step 1202 that the reproduction key is invalid, the processing is terminated at step 1206 without reproducing the audio data in terminal 10.

As described above, in the fourth embodiment, upon receipt of a reproduction request from terminal 10, license server 21 determines the validity for a reproduction key, and requests data server 22 to deliver audio data when it determines that the reproduction key is valid. The reproduction key can thus be protected from fraudulent use.

Fifth Embodiment

While the first through fourth embodiments have been described in connection with the audio data recording/reproducing systems which are configured to record audio data on a CD accompanied with a CD-ID, a fifth embodiment is configured to support even a CD accompanied with no CD-ID.

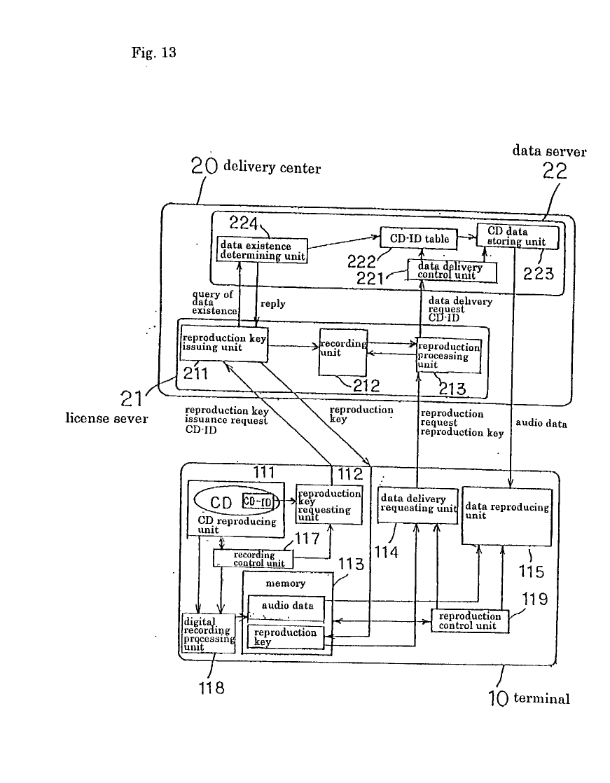

As illustrated in FIG. 13, the fifth embodiment differs from the first embodiment in that terminal 10 is provided therein with recording control unit 117, digital recording processing unit 118, and reproduction control unit 119.

Digital recording processing unit 118 digitally stores audio data on a CD loaded in CD reproducing unit 111 for storage in memory 113.

Recording control unit 117 determines whether or not a CD-ID is added to the CD loaded in CD reproducing unit 111. When a CD-ID is added, recording control unit 117 causes reproduction key requesting unit 112 to transmit a reproduction key issuance request to license server 21. When no CD-ID is added, recording control unit 117 controls digital recording processing unit 118 to digitally record the audio data on the CD.

Reproduction control unit 119 determines whether or not audio data on a CD stored in memory 113 is recorded as a reproduction key. When the audio data is recorded as a reproduction key, reproduction control unit 119 causes data delivery requesting unit 114 to transmit a reproduction request from to license server 21. When the audio data is not recorded as a reproduction key, reproduction control unit 119 controls data reproduction unit 115 to reproduce the audio data on the CD recorded in memory 113.

In the following, the operation of the foregoing audio data recording/reproducing system will be explained with reference to flow charts.

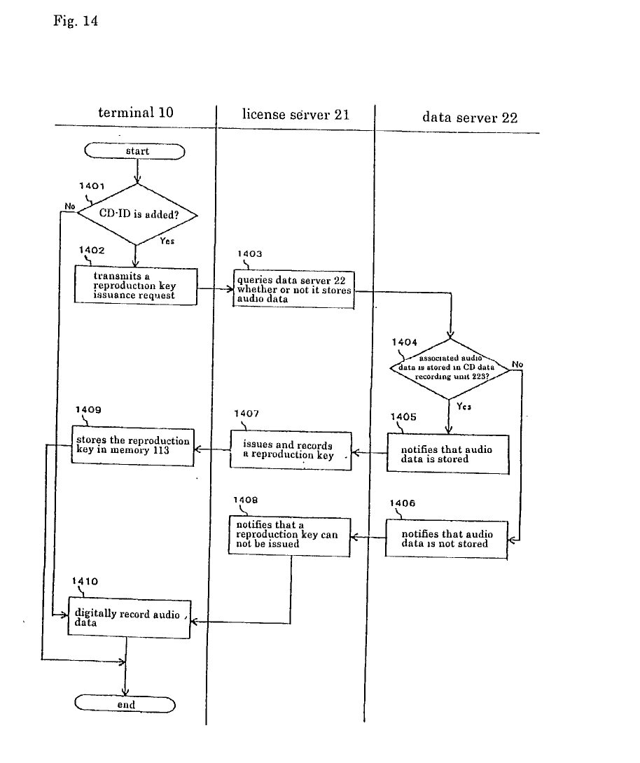

First, the operation for recording audio data will be explained with reference to a flow chart of FIG. 14.

At first, recording control unit 117 in terminal 10 determines at step 1401 whether or not a CD-ID is added to a CD loaded in CD reproducing unit 111. When no CD-ID is added, recording control unit 117 instructs digital recording processing unit 118 at step 1410 to digitally record audio data on the CD for storage in memory 113.

On the other hand, when a CD-ID is added as determined at step 1401, reproduction key requesting unit 112 extracts the CD-ID from the CD and transmits a reproduction key issuance request including the CD-ID to license server 21 at step 1402.

Upon receipt of the reproduction key issuance request from terminal 10, reproduction key issuing unit 211 in license server 21 queries data server 22 at step 1403 whether or not data server 222 stores audio data on a CD accompanied with the CD-ID included in the issuance request.

Data existence determining unit 224 in data server 22 determines at step 1404 whether or not associated audio data is stored in CD data recording unit 223 by referencing CD-ID table 222, and notifies license server 21 of the result at steps 1405, 1406.

When license server 21 is notified from data server 22 that audio data is stored therein, reproduction key issuing unit 211 issues a reproduction key to terminal 10, and recording unit 212 records the reproduction key issued to terminal 10 and the CD-ID from terminal 10 in relation to each other at step 1407. Conversely, when license server 21 is notified from data server 22 that no audio data is stored therein, reproduction key issuing unit 211 notifies terminal 10 that no reproduction key can be issued at step 1408.

Subsequently, when the reproduction key is issued in license server 21, the reproduction key is recorded in memory 113 in terminal 10 at step 1409, followed by termination of the processing. Conversely, when terminal 10 is notified that no reproduction key can be issued, recording control unit 117 instructs digital recording processing unit 118 to digitally record audio data on the CD for storage in memory 13 at step 1410.

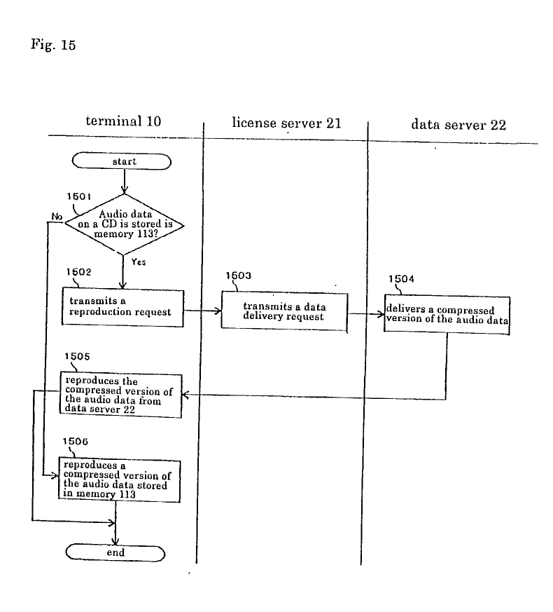

Next, the operation for reproducing audio data will be explained with reference to flow chart of FIG. 15.

First, at step 1501, reproduction control unit 119 in terminal 10 determines whether or not audio data on a CD stored in memory 113 is recorded as a reproduction key. When the audio data is not stored as a reproduction key, reproduction control unit 119 instructs data reproduction unit 115 to reproduce a compressed version of the audio data stored in memory 113 at step 1506.

On the other hand, when the reproduction control unit 119 determines at step 1501 that the audio data is stored in memory 113 as a reproduction key, data delivery requesting unit 114 reads the reproduction key stored in memory 113 and transmits a reproduction request including the reproduction key to license server 21 at step 1502.

Upon receipt of the reproduction request from terminal 10, reproduction processing unit 213 in license server 21 acquires a CD-ID corresponding to the reproduction key included in the reproduction request by referencing recording unit 212, and transmits a data sending request including the CD-ID to data server 22 at step 1503.

Upon receipt of the data sending request from license server 21, data delivery control unit 221 in data server 22 recognizes audio data on a CD accompanied with the CD-ID included in the data sending request by referencing CD-ID table 222, and instructs CD data recording unit 223 to deliver a compressed version of the audio data to terminal 10 at step 1504.

Subsequently, at step 1505, data reproducing unit 115 in terminal 10 reproduces the compressed version of the audio data delivered from data server 22 in real time, followed by termination of the processing.

As described above, in the fifth embodiment, it is determined in terminal 10 whether or not a CD-ID is added to a CD when audio data is stored, and a reproduction key issuance request is made to license server 21 when the CD-ID is added, while the audio data on the CD is digitally recorded when no CD-ID is added. On the other hand, when audio data is reproduced, it is determined whether or not the audio data is stored in memory 113 as a reproduction key, and a reproduction request is made to license server 21 when recorded as a reproduction key, and audio data stored in memory 113 is reproduced as it is -when not stored as a reproduction key. Thus, audio data on a CD can be recorded and reproduced irrespective of whether or not a CD-ID is added to the CD.

While the foregoing embodiments have been described in connection with the systems which are configured to record and reproduce audio data on a CD accompanied with a CD-ID as ID information, the present invention can be applied to other recording media accompanied with ID information.

Also, in the present invention, two or more of the aforementioned second through fifth embodiments may be combined as appropriate.

In addition to the processing within license server 21 and terminal 10 implemented by dedicated hardware, a program for implementing their functions may be recorded on a computer readable recording medium, and the program recorded on the recording medium may be read into a computer system for execution. The computer readable recording medium refers to a recording medium such as a floppy disk, a magneto-optical disk, a CD-ROM and the like, and a recording device such as a hard disk drive contained in a computer system. Further, the computer readable recording medium includes such one that dynamically holds a program for a short time period, as is the case with transmission of a program through the Internet (transmission medium or transmission wave), and such one that holds a program for a fixed time period such as a volatile memory within a computer system which functions as a server.

While preferred embodiments of the present invention have been described using specific terms, such description is for illustrative purposes only, and it is to be understood that changes and variations may be made without departing from the spirit or scope of the following claims.

What is claimed is:

1. An audio data delivery apparatus for permitting a terminal to record and reproduce audio data on a plurality of recording media, said audio data delivery apparatus comprising:
a data server for storing therein audio data on a plurality of recording media; and
a license server for issuing a reproduction key to said terminal for reproducing audio data on a recording medium indicated by said terminal within the audio data on the recording media stored in said data server when the audio data on the recording medium is recorded in said terminal, and for instructing said data server to deliver the audio data on the recording medium, indicated by said terminal, corresponding to said reproduction key from said data server to said terminal when the audio data on the recording medium is reproduced in said terminal.

2. The apparatus according to claim 1, wherein said terminal comprises:
reproduction key requesting means, operative when the audio data on said recording medium is recorded in said terminal, for transmitting a reproduction key issuance request for a reproduction key for reproducing the audio data on said recording medium to said license server, said reproduction key including ID information added to said recording medium;
a memory for storing the reproduction key issued by said license server;
data delivery requesting means, operative when audio data on a recording medium is reproduced corresponding to said reproduction key stored in said memory, for transmitting a reproduction request for the audio data on the recording medium corresponding to said reproduction key to said license server, said reproduction request including said reproduction key; and
data reproducing means for reproducing the audio data on said recording medium delivered from said data server.

3. The apparatus according to claim 2, wherein said data server comprises:
data recording means for storing the audio data on said plurality of recording media;
a table for recording therein the audio data on the recording media stored in said data recording means and ID information added to said recording media in relation to each other; and
data delivery control means for recognizing audio data on a recording medium accompanied with ID information included in a data delivery request by referencing said table, when said data delivery request is transmitted from said license server, to control a delivery of the audio data on said recording medium from said data recording means to said terminal.

4. The apparatus according to claim 2, wherein said license server comprises:
reproduction key issuing means, operative when said reproduction key issuance request is transmitted from said terminal, for issuing a reproduction key corresponding to ID information included in said reproduction key issuance request to said terminal;
recording means for recording therein the reproduction key issued by said reproduction key issuing means and ID information of the recording medium corresponding to said reproduction key in relation to each other; and
reproduction processing means, operative when said reproduction request is transmitted from said terminal, for recognizing ID information of the recording medium corresponding to said reproduction key included in said reproduction request by referencing said recording means, and transmitting to said data server a data delivery request for audio data on the recording medium accompanied with said ID information, said data delivery request including said ID information.

5. The apparatus according to claim 2, wherein said data server comprises:
data recording means for recording therein the audio data on said plurality of recording media;
a table for recording the audio data on the recording media recorded in said data recording means and ID information added to said recording media in relation to each other;
data delivery control means for recognizing audio data on a recording medium accompanied with ID information included in a data delivery request by referencing said table, when said data delivery request is transmitted from said license server, to control a delivery of the audio data on said recording medium from said data recording means to said terminal; and
data existence determining means for determining whether or not audio data on a recording medium queried by said license server is recorded in said data recording means by referencing said table.

6. The apparatus according to claim 5, wherein said license server comprises:
reproduction key issuing means, operative when said reproduction key issuance request is transmitted from said terminal, for querying said data server whether or not said data server stores therein audio data on a recording medium accompanied with ID information included in said reproduction key issuance request, and issuing said reproduction key to said terminal when said data existence determining means determines that the queried audio data is stored in said data server;
recording means for recording therein the reproduction key issued by said reproduction key issuing means and ID information of a recording medium corresponding to said reproduction key in relation to each other; and
reproduction processing means, operative when said reproduction request is transmitted from said terminal, for recognizing ID information of a recording medium corresponding to the reproduction key included in said reproduction request by referencing said recording means, and transmitting to said data server a data delivery request for audio data on a recording medium accompanied with said ID information, said data delivery request including said ID information.

7. The apparatus according to claim 1, wherein said terminal comprises:
terminal ID storing means for storing a terminal ID of said terminal;
reproduction key requesting means, operative when audio data on said recording medium is recorded in said terminal, for transmitting a reproduction key issuance request for a reproduction key for reproducing the audio data on said recording medium to said license server, said reproduction key including ID information added to said recording medium and the terminal ID stored in said terminal ID storing means;
a memory for storing the reproduction key issued by said license server;
data delivery requesting means, operative when audio data on a recording medium is reproduced corresponding to said reproduction key stored in said memory, for transmitting a reproduction request for the audio data on the recording medium corresponding to said reproduction key to said license server, said reproduction request including said reproduction key; and
data reproducing means for reproducing the audio data on the recording medium delivered from said data server.

8. The apparatus according to claim 7, wherein said data server comprises:
data recording means for recording therein the audio data on said plurality of recording media;
a table for recording the audio data on the recording media recorded in said data recording means and ID information added to said recording media in relation to each other;
data delivery control means for recognizing audio data on a recording medium accompanied with ID information included in a data delivery request by referencing said table, when said data delivery request is transmitted from said license server, to control a delivery of the audio data on said recording medium from said data recording means to said terminal; and
data existence determining means for determining whether or not audio data on a recording medium queried from said license server is recorded in said data recording means by referencing said table.

9. The apparatus according to claim 8, wherein said license server comprises:
recording means for recording therein for each said terminal a reproduction key issued to said terminal, ID information of a recording medium corresponding to said reproduction key, and the number of times said reproduction key has been issued in relation to one another;
reproduction key issuing means, operative when said reproduction key issuance request is transmitted from said terminal, for recognizing said terminal based on a terminal ID included in said reproduction key issuance request, recognizing the number of times a reproduction key corresponding to ID information included in said reproduction key issuance request has been issued to said terminal by referencing said recording means, and issuing said reproduction key to said terminal when said number of times of issuances is less than a predetermined allowable number of times;
reproduction processing means, operative when said reproduction request is transmitted from said terminal, for recognizing ID information of a recording medium corresponding to a reproduction key included in said reproduction request by referencing said recording means, and transmitting to said data server a data delivery request for audio data on a recording medium accompanied with said ID information, said data delivery request including said ID information.

10. The apparatus according to claim 5, wherein said license server comprises:
reproduction key issuing means, operative when said reproduction key issuance request is transmitted from said terminal, for issuing a reproduction key corresponding to ID information included in said reproduction key issuance request to said terminal;
recording means for recording therein said reproduction key, ID information of a recording medium corresponding to said reproduction key, and validity of said reproduction key in relation to one another; and
reproduction processing means, operative when said reproduction request is transmitted from said terminal, for determining whether or not a reproduction key included in said reproduction request is valid by referencing said recording means, and transmitting to said data server said data delivery request including ID information corresponding to the reproduction key included in said reproduction request only when determining that said reproduction key is valid.

11. The apparatus according to claim 1, wherein said terminal comprises:
reproduction key requesting means for transmitting a reproduction request for an audio data on a recording medium corresponding to said reproduction key to said license server, said reproduction request including said reproduction key, and for transmitting to said license server a reproduction key issuance request for a reproduction key for reproducing the audio data on said recording medium, said reproduction key issuance request including ID information added to said recording medium, when the audio data on said recording medium is recorded in said terminal;
a memory for recording a reproduction key issued in said license server;
data delivery requesting means, operative when audio data on a recording medium is reproduced corresponding to said reproduction key recorded in said memory, for transmitting a reproduction request for the audio data on the recording medium corresponding to said reproduction key to said license server, said reproduction request including said reproduction key;
data reproducing means for reproducing the audio data on the recording medium delivered from said data server;
digital recording processing means for digitally recording the audio data on said recording medium for storage in said memory; and
recording control means for determining whether or not said ID information is added to said recording medium when the audio data on said recording medium is recorded in said terminal, controlling said reproduction key requesting means to transmit said reproduction key issuance request when determining that said ID information is added to said recording medium, and controlling said digital recording processing means to digitally record the audio data on said recording medium when determining that said ID information is not added to said recording medium.

12. The apparatus according to claim 11, wherein said terminal further comprises:
reproduction control means for determining whether or not audio data on said recording medium is recorded as said reproduction key when the audio data on said recording medium stored in said memory is reproduced in said terminal, controlling said data delivery requesting means to transmit said reproduction request when determining that the audio data on said recording medium is stored as said reproduction key, and controlling said data reproducing means to reproduce the audio data on said recording medium stored in said memory when determining that the audio data on said recording medium is not recorded as said reproduction key.

13. The apparatus according to claim 11, wherein said data server further comprises:
data recording means for recording therein the audio data on said plurality of recording media;
a table for recording therein audio data on recording media recorded in said data recording means and ID information added to said recording media in relation to each other;
data delivery control means for recognizing audio data on a recording medium accompanied with ID information included in said data delivery request by referencing said table, when said data delivery request is transmitted from said license server, to control a delivery of the audio data on said recording medium from said data recording means to said terminal; and
data existence determining means for determining whether or not audio data on a recording medium queried by said license server is recorded in said data recording means by referencing said table.

14. The apparatus according to claim 13, wherein said license server further comprises:
reproduction key issuing means for querying said data server whether or not said data server stores audio data on a recording medium accompanied with ID information included in said reproduction key issuance request, when said reproduction key issuance request is transmitted from said terminal, and issuing said reproduction key to said terminal when said data existence determining means determines that the queried audio data is stored in said data server;
recording means for recording therein a reproduction key issued by said reproduction key issuing means and ID information of a recording medium corresponding to said reproduction key in relation to each other; and
reproduction processing means for recognizing ID information of a recording medium corresponding to a reproduction key included in said reproduction request when said reproduction request is transmitted from said terminal by referencing said recording means, and transmitting to said data server a data delivery request for audio data on a recording medium accompanied with said ID information, said data delivery request including said ID information.

15. A terminal for recording and reproducing audio data on a plurality of recording media utilizing an audio data delivery apparatus for recording audio data on a plurality of recording media, said terminal comprising:
reproduction key requesting means, operative when audio data on said recording medium is recorded in said terminal, for transmitting a reproduction key issuance request for a reproduction key for reproducing the audio data on said recording medium to said license server, said reproduction key including ID information added to said recording medium;
a memory for storing the reproduction key issued by said license server;
data delivery requesting means, operative when audio data on a recording medium is reproduced corresponding to said reproduction key stored in said memory, for transmitting to said license server a reproduction request for the audio data on the recording medium corresponding to said reproduction key, said reproduction request including said reproduction key; and
data reproducing means for reproducing the audio data on the recording medium delivered from said data server.

16. A terminal for recording and reproducing audio data on a plurality of recording media utilizing an audio data delivery apparatus for recording audio data on a plurality of recording media, said terminal comprising:
terminal ID storing means for storing a terminal ID of said terminal;
reproduction key requesting means, operative when audio data on said recording medium is recorded in said terminal, for transmitting a reproduction key issuance request for a reproduction key for reproducing the audio data on said recording medium to said license server, said reproduction key including ID information added to said recording medium and the terminal ID stored in said terminal ID storing, means;
a memory for storing the reproduction key issued by said license server;
data delivery requesting means, operative when audio data on a recording medium is reproduced corresponding to said reproduction key stored in said memory, for transmitting to said license server a reproduction request for the audio data on the recording medium corresponding to said reproduction key, said reproduction request including said reproduction key; and
data reproducing means for reproducing the audio data on the recording medium delivered from said data server.

17. A terminal for recording and reproducing audio data on a plurality of recording media utilizing an audio data delivery apparatus for recording audio data on a plurality of recording media, said terminal comprising:
reproduction key requesting means for transmitting to a license server a reproduction request for an audio data on a recording medium corresponding to a reproduction key, said reproduction request including said reproduction key, and for transmitting to said license server a reproduction key issuance request for a reproduction key for reproducing the audio data on said recording medium, said reproduction key issuance request including ID information added to said recording medium, when the audio data on said recording medium is recorded in said terminal;
a memory for storing a reproduction key issued by said license server;
data delivery requesting means, operative when audio data on a recording medium is reproduced corresponding to said reproduction key stored in said memory, for transmitting to said license server a reproduction request for the audio data on the recording medium corresponding to said reproduction key, said reproduction request including said reproduction key;
data reproducing means for reproducing the audio data on the recording medium delivered from a data server;
digital recording processing means for digitally recording the audio data on said recording medium for storage in said memory; and
recording control means for determining whether or not said ID information is added to said recording medium when the audio data on said recording medium is recorded in said terminal, controlling said reproduction key requesting means to transmit said reproduction key issuance request when determining that said ID information is added to said recording medium, and controlling said digital recording processing means to digitally record the audio data on said recording medium when determining that said ID information is not added to said recording medium.

18. The terminal according to claim 17, further comprising:
reproduction control means for determining whether or not the audio data on said recording medium is stored as said reproduction key when the audio data on said recording medium stored in said memory is reproduced in said terminal, controlling said data delivery requesting means to transmit said reproduction request when determining that the audio data on said recording medium is stored as said reproduction key, and controlling said data reproducing means to reproduce the audio data on said recording medium stored in said memory when determining that the audio data on said recording medium is not stored as said reproduction key.

19. The terminal according to claim 15, wherein said memory is portable.

20. A computer program for enabling a computer to execute processing for permitting a terminal to record and reproduce audio data on a plurality of recording media, said computer program comprising:
a first instruction set, executable when said terminal records audio data on a recording medium, for issuing a reproduction key to said terminal, for reproducing the audio data on the recording medium indicated by said terminal from among recorded audio data on recording media; and
a second instruction set, executable when said terminal reproduces audio data on a recording medium, for delivering to said terminal the audio data on the recording medium corresponding to said reproduction key indicated by said terminal.

21. A computer program for enabling a computer to execute processing for permitting a terminal to record and reproduce audio data on a plurality of recording media, said computer program comprising:
a first instruction set, executable when a reproduction key issuance request is transmitted from said terminal, for issuing a reproduction key corresponding to ID information included in said reproduction key issuance request to said terminal;
a second instruction set for recording a reproduction key issued by said first instruction set and ID information of a recording medium corresponding to said reproduction key in relation to each other in recording means; and
a third instruction set, executable when said reproduction request is transmitted from said terminal, for recognizing ID information of a recording medium corresponding to the reproduction key included in said reproduction request by referencing said recording means, and transmitting to said data server a data delivery request for audio data on a recording medium accompanied with said ID information, said data delivery request including said ID information.

22. A computer program for enabling a computer to execute processing for permitting a terminal to record and reproduce audio data on a plurality of recording media, said computer program comprising:
a first instruction set, executable when a reproduction key issuance request is transmitted from said terminal, for querying a data server whether or not said data server stores audio data on a recording medium accompanied with ID information included in said reproduction key issuance request, and issuing a reproduction key to said terminal when said data server stores the queried audio data;
a second instruction set for recording said reproduction key issued by said first instruction set and ID information of a recording medium corresponding to said reproduction key in relation to each other in recording means; and
a third instruction set, executable when a reproduction request is transmitted from said terminal, for recognizing ID information of a recording medium corresponding to a reproduction key included in said reproduction request by referencing said recording means, and transmitting to said data server a data delivery request for audio data on a recording medium accompanied with said ID information, said data delivery request including said ID information.

23. A computer program for enabling a computer to execute processing for permitting a terminal to record and reproduce audio data on a plurality of recording media, said computer program comprising:
a first instruction set, executable when a reproduction key issuance request is transmitted from said terminal, for recognizing said terminal based on a terminal ID included in said reproduction key issuance request, recognizing the number of times a reproduction key corresponding to ID information included in said reproduction key issuance request has been issued to said terminal by referencing recording means, said recording means recording therein for each said terminal a reproduction key issued for said terminal, ID information of a recording medium corresponding to said reproduction key, and the number of times said reproduction key has been issued in relation to one another, and issuing said reproduction key to said terminal when the number of times of issuances is less than a predetermined allowable number of times;
a second instruction set, executable when a reproduction request is transmitted from said terminal, for recognizing ID information of a recording medium corresponding to a reproduction key included in said reproduction request by referencing said recording means, and transmitting to a data server a data delivery request for audio data on a recording medium accompanied with said ID information, said data delivery request including said ID information.

24. A computer program for enabling a computer to execute processing for permitting a terminal to record and reproduce audio data on a plurality of recording media, said computer program comprising:
a first instruction set, executable when a reproduction key issuance request is transmitted from said terminal, for issuing a reproduction key corresponding to ID information included in said reproduction key issuance request to said terminal; and
a second instruction set, executable when a reproduction request is transmitted from said terminal, for determining whether or not a reproduction key included in said reproduction request is valid by referencing recording means, said recording means recording therein said reproduction key, ID information of a recording medium corresponding to said reproduction key, and validity of said reproduction key in relation to one another, and transmitting to a data server a data delivery request including ID information corresponding to the reproduction key included in said reproduction request, when determining that said reproduction key is valid.

25. A computer program for enabling a computer to execute processing for recording and reproducing audio data on a plurality of recording media utilizing an audio data delivery apparatus for recording audio data on a plurality of recording media, said computer program comprising:
a first instruction set, executable when recording audio data on said recording medium, for transmitting to said audio data delivery apparatus a reproduction key issuance request for a reproduction key for reproducing the audio data on said recording medium, said reproduction key issuance request including ID information added to said recording medium;
a second instruction set, executable when reproducing audio data on a recording medium corresponding to a reproduction key stored in a memory, said memory storing said reproduction key issued by said audio data delivery apparatus, for transmitting to a license server a reproduction request for audio data on a recording medium corresponding to said reproduction key, said reproduction request including said reproduction key; and
a third instruction set for reproducing audio data on a recording medium delivered from said audio data delivery apparatus.

26. A computer program for enabling a computer to execute processing for recording and reproducing audio data on a plurality of recording media utilizing an audio data delivery apparatus for recording audio data on a plurality of recording media, said computer program comprising:
a first instruction set, executable when recording audio data on said recording medium, for transmitting to a license server a reproduction key issuance request for a reproduction key for reproducing the audio data on said recording medium, said reproduction key issuance request including ID information added to said recording medium, and a terminal ID stored in terminal ID storing means for storing the terminal ID of said terminal;
a second instruction set, executable when reproducing audio data on a recording medium corresponding to said reproduction key stored in a memory, said memory storing a reproduction key issued by said audio data delivery apparatus, for transmitting to said audio data delivery apparatus a reproduction request for audio data on a recording medium corresponding to said reproduction key, said reproduction request including said reproduction key; and
a third instruction set for reproducing audio data on a recording medium delivered from a data server.

27. A computer program for enabling a computer to execute processing for recording and reproducing audio data on a plurality of recording media utilizing an audio data delivery apparatus for recording audio data on a plurality of recording media, said computer program comprising:
a first instruction set for transmitting to said audio data delivery apparatus a reproduction request for audio data on a recording medium corresponding to a reproduction key, said reproduction request including said reproduction key, and for transmitting ID information added to said recording medium to said audio data delivery apparatus when recording the audio data on said recording medium;
a second instruction set for reproducing audio data on a recording medium delivered from said audio data delivery apparatus, corresponding to said reproduction key stored in a memory, said memory storing reproduction keys issued by said audio data delivery apparatus;
a third instruction set for digitally recording the audio data on said recording medium for storage in said memory; and
a fourth instruction set, executable when recording the audio data on said recording medium, for determining whether or not said ID information is added to said recording medium, controlling said first instruction set to transmit a reproduction key issuance request when determining that said ID information is added to said recording medium, and controlling said third instruction set to digitally record the audio data on said recording medium when determining that said ID information is not added to said recording medium.

28. The computer program according to claim 27, further comprising a fifth instruction set, executable when reproducing the audio data on said recording medium stored in said memory, for determining whether or not the audio data on said recording medium is stored as said reproduction key, controlling to transmit said reproduction request when determining that the audio data on said recording medium is stored as said reproduction key, and controlling to reproduce the audio data on the recording medium stored in said memory when determining that the audio data on said recording medium is not stored as said reproduction key.
